(19) United States
(12) Patent Application Publication
(10) Pub. No.: US 2005/0225643 A1
(43) Pub. Date: Oct. 13, 2005

(54) Context enhanced pictures

(76) Inventor: Raphael Grignani, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/092,883

(22) Filed: Mar. 29, 2005

(30) Foreign Application Priority Data
Mar. 30, 2004 (GB) 0407139.5

(51) Int. Cl. H04N 5/225

(52) U.S. Cl. 348/207.99

(57) ABSTRACT

A portable electronic data capture apparatus comprising one or more audio and/or video sensors for sensing audio and/or video so as to generate sensed data, a receiver for receiving a wireless signal carrying content data descriptive of the locale of the apparatus and a recorder for recording the sensed data in association with the content data.

This invention relates to data capture apparatus, and especially to the automatic annotation of digital images with information that is available when the image is created. For example, the digital images might be photographs taken using a digital camera and the information might be data that is available to the camera in the location where the photograph is taken.

Advances in the technology used to create mobile devices mean that different devices are now commonly able to interact and communicate with each other. Although mobile devices have been able to communicate with other devices for some years now (for instance, mobile phones are able to communicate with each other) this communication has been limited to between devices of the same type. Devices that are now able to interact and communicate include devices from different product families. It is envisaged that devices such as mobile phones and digital cameras will now be able to interact and communicate with each other using technology such as Bluetooth (“RTM”), Multimedia Messaging (MMS) and Pop-Port (“RTM”).

Bluetooth is a new technology for wireless connectivity. It is based on a short-range radio link that can provide a wireless connection for many types of digital devices. In order to establish a connection between two devices, they typically have to be within 10 metres of each other. The devices do not need to have a line-of-sight connection between them in order to communicate. As an example, a laptop computer could utilise Bluetooth technology to wirelessly control a printer in the next room.

Wireless local area networks (WLANs) extend the reach of local area networks (LANs) by allowing mobile devices to connect with wired LANs via a wireless connection. WLANs allow easy, wireless access to broadband data rates. For example, instead of accessing a corporate network by plugging a PC into a wired wall outlet, the corporate network can be accessed through the PC and a wireless LAN card. Zones for accessing a WLAN can be established, for instance at airports or hotels, to allow users to connect to their corporate network via the internet.

The Pop-Port interface is a new interface for the next generation of mobile phones. It allows several functions to be incorporated into one interface. For example, using the Pop-Port interface connector it will be possible to control cameras, digital music players and stereo headsets and other devices through the mobile phone. Further features of the interface may include supporting high-speed data connectivity, stereo audio for integrated audio devices, power output functionality (thereby removing the need for a separate battery with the accessory) and digital identification for recognising attached accessories and setting optimised parameters in the phone.

Multimedia messaging is similar to the traditional short messaging service (SMS), in that it provides automatic and immediate delivery of personal messages. Unlike SMS, MMS allows users to incorporate data-rich content, such as sound and images, into their messages. In addition, MMS increases the possibilities for mobile communication, both for private and corporate use, by enabling users to send multimedia messages, not only from one phone to another, but also from phone to e-mail and vice-versa.

The possibilities opened up by these new technologies have not yet been fully exploited, in particular, the possibilities to enable communication across different product families.

Digital cameras have become extremely popular and their use is now widespread. Digital cameras are typically optimised for taking photographs and often have limited previewing and editing functions. Although some digital cameras do insert basic metadata such as the time/date or light or exposure settings into the images, they do not gather additional information that is relevant to the content or context of a picture.

Users of digital cameras are typically now taking a large number of pictures. As a result they form large image collections, which have to be sorted and categorised if they are to be viewed conveniently. Many users also wish to annotate, or otherwise associate, images with details of the place where the image was taken and who was present at the time. This has to be done manually: by the user reviewing the images, recalling what they show, and adding the information, for instance by typing it in. This is a tedious job.

To facilitate the management of large collections of images, it would be useful if the images were automatically annotated with relevant information, such as location, people present etc.

Therefore, there is a need for a digital device that automatically annotates images taken using the device with information gathered at the time the image is taken.

According to the present invention, there is provided a portable electronic data capture apparatus comprising one or more audio and/or video sensors for sensing audio and/or video so as to generate sensed data, a receiver for receiving a wireless signal carrying content data descriptive of the locale of the apparatus and a recorder for recording the sensed data in association with the content data.

The receiver may be capable of receiving the wireless signal and extracting the content data therefrom. The content data may be carried in data packets of the wireless signal.

The portable electronic data capture apparatus may comprise a situational data sensor for sensing situational data at the device and the recorder may be capable of recording the sensed data in association with the situational data.

Suitably, the situational data may include an environmental condition, the location of the device or the physical orientation of the apparatus. The situational data sensor may comprise a satellite positioning device capable of determining the location of the apparatus by receiving and processing satellite positioning signals.

In one embodiment of the present invention, the or at least one of the audio and/or video sensor(s), the receiver and the recorder are housed in a common housing. In another embodiment, the or at least one of the audio and/or video sensor(s), and the recorder are housed in a first housing, and the receiver is housed in a second housing separate from the first housing, and the apparatus comprises: a second receiver located in the first housing and a transmitter located in the second housing, the transmitter and the second receiver being capable of communicating so as to convey the content data from the first receiver to the recorder.

Suitably, the second housing houses a mobile phone.

Preferably, the transmitter and the second receiver are capable of communicating wirelessly with each other.

The content data may be received from communication with a mobile telephone network and the first receiver may comprise a mobile telephone network receiver for generating the content data.

The wireless signal may be a radio signal. The radio signal may be a short-range radio signal. The wireless signal may be a Bluetooth signal or a wireless LAN signal. The wireless signal may be a radio frequency identification (RFID) signal.

The portable electronic data capture apparatus can be arranged to passively receive the wireless signal. Alternatively, the apparatus comprises a second transmitter for communicating with a source of the said wireless signal and the apparatus is arranged to request the content data by transmitting a request signal by means of the second transmitter.

Suitably the apparatus is actuable by a user to sense audio and/or video and is arranged to request the content data on such actuation.

According to an embodiment of the present invention, the apparatus is capable of wirelessly receiving from transmitting devices in the vicinity of the apparatus identifying signals including identities that identify those devices, and recording data dependent on at least some of those identities in conjunction with the sensed data.

The apparatus may comprise a store for storing names corresponding to such identities, and wherein the apparatus is arranged to identify names corresponding to received identities and to record names corresponding to received identities in conjunction with the sensed data. Preferably, the apparatus is arranged to record data dependent on a sensed identity only if the apparatus has received the identifying signal including that identity over a predetermined period of time. The apparatus may be arranged to record sensed data sensed on a first occasion in association with content data sensed on the first occasion and to record at least some of the sensed data sensed on a second occasion in association with the content data sensed on the first occasion if the second occasion is within a predetermined time of the first occasion.

Suitably the apparatus comprises a switch that has a default configuration and is user-operable to move from the default configuration to a first actuation configuration and to move from a first actuation configuration to a second actuation configuration. Suitably the apparatus is responsive to the switch to gather content data when the switch is moved to the first actuation configuration. The apparatus may be responsive to the switch to record content data when the switch is moved to the second actuation configuration. The apparatus may also be responsive to the switch to perform an operation to prepare the audio and/or video sensor(s) for operation when the switch is moved to the first actuation configuration. The apparatus may be responsive to the switch to sense audio and/or video data by means of the audio and/or video sensor(s) when the switch is moved to the second actuation configuration.

Preferably the apparatus is arranged to record sensed data in association with an indication of the time at which the sensed data is generated. The apparatus may also be arranged to record sensed data in association with data that is indicative of the parameters under which the apparatus was operating during the sensing of the audio and/or video.

The recorder may be arranged to record the sensed data and the content data in the same data file. Alternatively, the recorder may be arranged to record the sensed data and the content data in linked files.

Preferably the apparatus is capable of presenting the sensed data and the content data to a user.

Preferably the recorder is arranged to record the sensed data and the secondary data in non-volatile memory.

According to the present invention, there is provided a method of operating a portable electronic data capture apparatus, the method comprising sensing audio and/or video by means of one or more audio and/or video sensors so as to generate sensed data, receiving a wireless signal carrying content data descriptive of the locale of the apparatus and recording the sensed data in association with the content data.

According to the present invention, there is provided a content data distribution system comprising a plurality of transmitters, each transmitter being sited at a data site and being arranged to transmit wireless signals carrying content data descriptive of the locale of the transmitter and an electronic data capture apparatus, the electronic data capture apparatus being capable of receiving by means of the receiver thereof the wireless signals transmitted by the transmitters.

Suitably, the wireless signals are radio signals. The radio signals may be short-range radio signals. The wireless signals may be Bluetooth signals. The wireless signal may be wireless LAN signals.

The apparatus may be arranged to passively receive the wireless signal.

Each of the said transmitters may be associated with a respective receiver for receiving request signals from the portable electronic data capture device and may be responsive to receiving such a request signal to transmit the said wireless signals carrying content data.

Suitably each of the said plurality of transmitters is a terrestrially mounted transmitter.

Suitably each data site is a fixed location.

The present invention will now be described by way of example, with reference to the accompanying drawings, in which:

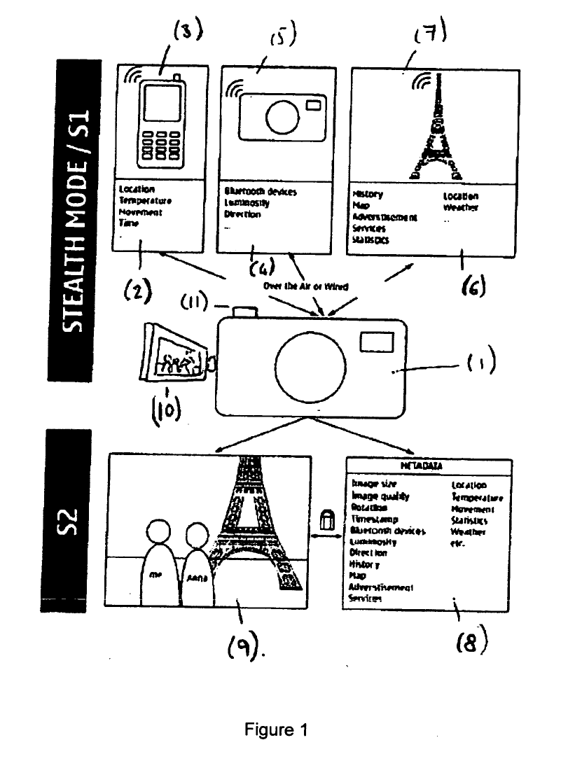

FIG. 1 illustrates an example of a situation in which the device of the present invention may be utilised.

The present invention will be described in relation to a digital still camera. Such a camera is capable of capturing video data in the form of still images represented in a digital form. This is by way of example only and it should be understood that the present invention is applicable to other portable devices capable of data capture, for example, sound recorders, video cameras and analogue cameras. If video cameras are used to implement the present invention, it should be understood that the association of context data with captured images is equally applicable to still images that are captured by the video camera as to video images.

A digital camera for implementing the present invention is preferably capable of wireless or wired communication with other devices. The present invention will be described in relation to a camera that is capable of communication using Bluetooth technology. This is for the purposes of example only and the invention could be implemented using any wireless technology (e.g. W-LAN, RFID, UWB) or wired technology (e.g. Pop-Port). Short-range wireless devices, for example having an effective range of 20 m or 10 m or less, are preferred.

The camera may suitably be always in “Bluetooth discoverable mode”. This means that the camera is always open to receiving data from the surrounding environment. This data can be, for example, information regarding services and devices in the vicinity of the camera. More specifically, the data may include information relating to the location, time, temperature, weather, altitude, surrounding devices or people, or may include text or audio streams, such as advertisements or descriptions of events. The information carried by the data may be received in one of two forms. First, the data may be received as content within the received signal, the received signal carrying data that directly defines the content. For example, the received signal may include packets of data that represent text describing the location. Second, the data may be obtained by processing one or more received signals to locally determine what information is imported by the signals. For example, the signals may be GPS data streams from a number of satellites, which are processed locally to determine the location of the camera.

The camera may gather data from a variety of sources. For example, the data may be transmitted by other devices, such as mobile phones or other digital cameras. There are a growing number of Bluetooth devices in circulation. These are not just limited to mobile devices, such as mobile phones or laptop computers, but also comprise a growing number of devices, located in both public and private spaces, which are capable of transmitting Bluetooth signals. Tourist sites in particular are locations that may include such devices and are especially appropriate to the present invention. These include, for example, places such as the Eiffel Tower, the Empire State Building, Disneyland and restaurants. There are also a growing number of WLAN “hotspots”, zones in which devices are enabled to access broadband data rates through a wireless connection, through which data may be gathered. These data sources are given for illustrative purposes only. The present invention may suitably function using any appropriate form of data transmission.

The camera may gather data from other neighbouring, portable devices. For example, if a Bluetooth enabled mobile phone is in the locality of the camera and transmitting an identification signal, the camera may detect this signal. The identifying signal may identify the owner of the phone. Alternatively, the camera may determine the identity of the owner by querying the phone or by searching a database containing identification signals and corresponding identifiers (such a database could be stored in the camera or could, for example, be an address book contained in a second, local mobile phone to which the camera is connected). In one preferred arrangement, the camera and/or a local mobile phone to which it is attached periodically determines what devices can be sensed (e.g. by Bluetooth) to be nearby. This may be done at set intervals, or when an action is taken: for instance the taking of a picture. The identities of the devices, or their owners, sensed at a time when data is captured may be annexed to captured data. If the camera is used in a crowded place then this could result in the annexing of the identities of many phones whose users are of no consequence to the user of the camera. Therefore, in one embodiment only a neighbouring device that has been sensed for a predetermined period of time, such as several hours, has its identity annexed to the data. This state indicates to the camera that the owner of that phone is accompanying the user of the camera. In another embodiment only a neighbouring device that has previously been paired with the camera or is in a list such as a “buddy list” stored on the camera has its identity annexed to the data. The camera suitably permits the user to select between the options for filtering the nearby devices' identities. This feature of the present invention therefore provides additional useful information relating to the context in which a photograph is taken.

The camera may be arranged to passively gather data that is transmitted by a second device. The camera may also be arranged to actively request data that it requires from a second device.

The transmitted data is preferably time-stamped: i.e. associated with data indicating the time at which it was captured.

The process of taking a picture can be considered as comprising two steps. A first step, in which the trigger is half-pressed by the user and the camera focuses and adjusts parameters accordingly, and a second step, in which the user fully presses the trigger and the camera takes a picture.

The camera is said to be in stealth mode when it gathers the available data. Preferably, when the user half-presses the trigger of the camera according to the first step for actuating the camera to take a photograph, the camera queries and gathers the available information. The camera also ensures that this information is up-to-date by checking the time-stamp against its internal clock. When the user fully presses the trigger according to the second step for actuating the taking of a photograph, the camera writes the gathered information as metadata attached to the image. If the user subsequently takes a second picture within a short time from the first (e.g. within three seconds), then the camera attaches the same information to the second image as was attached to the first. This is because it is assumed that the surroundings of the user and hence the context of the image cannot have changed from the first photograph. The camera could alternatively capture the data periodically, or after the picture is taken.

In order to request the data the camera may interact with other devices by transmitting a signal of a predefined format that those devices are arranged to recognise as a request for data. On receiving that signal those devices then transmit the appropriate data so that it can be received by the camera. Those signals may be carried by Bluetooth, for example.

The camera may filter the gathered data to remove inappropriate information, such as advertisements, that may not be of use to the user and thus would waste memory if it were stored.

In addition to the external data that is available to the camera, the camera may attach data that relates to the actual capture of the image, for instance, the time, light or exposure settings etc.

The metadata may be accessible from the camera e.g. through a “gallery” that allows users to view the pictures that they have taken. The metadata may also be accessible via PC applications, media viewers or any other application or device that is able to read the data.

Preferably the gathering and attaching operations are carried out automatically and do not require any input from the user.

The operation of a camera according to the present invention is further illustrated in FIG. 1. In this example, the camera (1) is paired with a mobile telephone (3) and can exchange information (2) freely with the phone without any intervention from the user. In this example the camera will employ the receiver of the phone to acquire content data about its locale. However, the phone and the camera could be integrated or the camera could include a specific receiver for acquiring the content data.

The user is visiting the Eiffel Tower with a friend, Anna. The Eiffel Tower (7) is equipped with Bluetooth transmitters that broadcast information (6) about the Tower, such as the history, shops, services, URLs statistics etc. The digital camera has access to this information. The camera may also communicate with other Bluetooth devices in the vicinity, shown generally at 5. For example, the camera may receive information from Anna's Bluetooth phone (not illustrated). The camera knows that the user is with Anna, since her Bluetooth phone has been in the vicinity for a substantial period of time. When the user takes a photograph (9), by pressing the trigger (11), the camera collects all the available information (8) and attaches it to the image to be stored. When the user later browses through the stored images, he will be able to read the information associated with each image. The user may view the stored images and information via the display (10). Therefore, the present invention enables he user to create enhance pictures that comprise not only the image itself, but also information related to the image which would not necessarily be available, or easily available, to the user.

A device according to the present invention is preferably arranged to enhance images by attaching information to the image that is relevant to the context in which the image was captured. This may increase the user's subsequent enjoyment of his photograph collection. It also makes the capturing and storing of large numbers of images more user-friendly, by giving the user additional tools for searching, organising and filtering the captured images. Situations in which the user would find it advantageous to have metadata such as that described above attached to their photographs are numerous and readily apparent. For example, the user may wish to search a gallery of photographs for those which were taken when they were with a particular friend or family member.

The invention is especially beneficial when applied to data capture devices that generate digital data files representative of captured data, in association with which the meta data can be stored. The camera may store the data in files. Preferably, the camera stores both the image data and the meta data that was gathered at the time the image was captured. This data may be stored in separate files. In which case, the files containing the image data and the meta data may be linked, such that the meta data file is stored as an accessory file to the image data file. The two files may be linked via entries in a table or database stored by the camera. For example, the meta data and the image data might be stored in linked files by using EXIF (Exchangeable Image File Format) or IPTC (International Press Telecommunications Council) standards. Alternatively, the image data and the meta data may be stored in the same file, e.g. by using XML (Extensible Mark-up Language).

According to an advantageous embodiment of the present invention, the camera may be paired with a second device, which enables it to collect more data than it could gather by itself. The second device could be a mobile telephone, a personal computer or a short-range base station. For example, the camera could be paired with a mobile phone, either via a wireless connection or through a wired connection (such as Pop-Port). If the camera is paired with a phone, it may have access to information that the phone can determine but which the camera cannot. For example, a phone can determine its location using the cell ID or GPS (Global Positioning System), whereas a typical camera may not be equipped to determine its location. Also, in the future, phones may be fitted with additional sensors. The data obtained from these sensors might be relevant to the situation in which a picture is taken and thus be attached to a corresponding image by the camera.

The image data and meta data are preferably stored in non-volatile memory.

The data that is received by the camera and stored in association with the audio/video captured by the camera is preferably received from a terrestrial data transmitter. The data transmitter is preferably a short range data transmitter, so that the user of the camera can be assured that the received data relates to the locale where the camera is being operated. This the range of the transmitter is preferably less than any one of 1 km, 500 m, 250 m, 100 m, 50 m, 20 m or 10 m. There may be multiple such transmitters at different locations, forming a system that allows camera users to gather data about the locale at which a photograph is taken. Those transmitters are preferably fixed in location, but could be mobile if the object about which they transmit data is mobile, for example a cruise ship or carnival float. In that case, when the mobile object is in a user's locale his camera will be able to receive data about that object.

The data transmitter may be of any suitable type. One example is a device that continually (whether uninterruptedly or periodically) broadcasts radio or other wireless signals for receipt by other devices. Such a transmitter may use a conventional data protocol such as a radio telephony protocol (e.g. GSM or 3G) or a data transfer protocol such as Bluetooth. Alternatively, the transmitter could send signals either by a broadcast or by a directed transmission on request from the camera. The data transmitter could alternatively be a radio frequency ID device or tag, which transmits its identity and associated content data either continually or on request.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

1. A portable electronic data capture apparatus comprising:
one or more audio and/or video sensors for sensing audio and/or video so as to generate sensed data;
a receiver for receiving a wireless signal carrying content data descriptive of the locale of the apparatus; and
a recorder for recording the sensed data in association with the content data.

2. A portable electronic data capture apparatus as claimed in claim 1, wherein the receiver is capable of receiving the wireless signal and extracting the content data therefrom.

3. A portable electronic data capture apparatus as claimed in claim 1, wherein the content data is carried in data packets of the wireless signal.

4. A portable electronic data capture apparatus as claimed in claim 1, comprising a situational data sensor for sensing situational data at the device, and wherein the recorder is capable of recording the sensed data in association with the situational data.

5. A portable electronic data capture apparatus as claimed in claim 4, wherein the situational data includes an environmental condition.

6. A portable electronic data capture apparatus as claimed in claim 4, wherein the situational data includes the location of the device.

7. A portable electronic data capture apparatus as claimed in claim 6, wherein the situational data sensor comprises a satellite positioning device capable of determining the location of the apparatus by receiving and processing satellite positioning signals.

8. A portable electronic data capture apparatus as claimed in claim 4, wherein the situational data includes the physical orientation of the apparatus.

9. A portable electronic data capture apparatus as claimed in claim 1, wherein the or at least one of the audio and/or video sensor(s), the receiver and the recorder are housed in a common housing.

10. A portable electronic data capture apparatus as claimed in claim 1, wherein the or at least one of the audio and/or video sensor(s), and the recorder are housed in a first housing, and the receiver is housed in a second housing separate from the first housing, and the apparatus comprises: a second receiver located in the first housing and a transmitter located in the second housing, the transmitter and the second receiver being capable of communicating so as to convey the content data from the first receiver to the recorder.

11. A portable electronic data capture device as claimed in claim 10, wherein the second housing houses a mobile phone.

12. A portable electronic data capture device as claimed in claim 10, wherein the transmitter and the second receiver are capable of communicating wirelessly with each other.

13. A portable electronic data capture apparatus as claimed in claim 6, wherein the content data is received from communication with a mobile telephone network and the first receiver comprises a mobile telephone network receiver for generating the content data.

14. A portable electronic data capture apparatus as claimed in claim 1, wherein the wireless signal is a radio signal.

15. A portable electronic data capture apparatus as claimed in claim 14, wherein the radio signal is a short-range radio signal.

16. A portable electronic data capture apparatus as claimed in claim 15, wherein the wireless signal is a Bluetooth signal or a wireless LAN signal.

17. A portable electronic data capture apparatus as claimed in claim 15, wherein the wireless signal is a radio frequency identification (RFID) signal.

18. A portable electronic data capture apparatus as claimed in claim 1, wherein the apparatus is arranged to passively receive the wireless signal.

19. A portable electronic data capture apparatus as claimed in claim 1, wherein the apparatus comprises a second transmitter for communicating with a source of the said wireless signal and the apparatus is arranged to request the content data by transmitting a request signal by means of the second transmitter.

20. A portable electronic data capture device as claimed in claim 19, wherein the apparatus is actuable by a user to sense audio and/or video and is arranged to request the content data on such actuation.

21. A portable electronic data capture apparatus as claimed in claim 1, wherein the apparatus is capable of wirelessly receiving from transmitting devices in the vicinity of the apparatus identifying signals including identities that identify those devices, and recording data dependent on at least some of those identities in conjunction with the sensed data.

22. A portable electronic data capture apparatus as claimed in claim 21, wherein the apparatus comprises a store for storing names corresponding to such identities, and wherein the apparatus is arranged to identify names corresponding to received identities and to record names corresponding to received identities in conjunction with the sensed data.

23. A portable electronic data capture apparatus as claimed in claim 21, wherein the apparatus is arranged to record data dependent on a sensed identity only if the apparatus has received the identifying signal including that identity over a predetermined period of time.

24. A portable electronic data capture apparatus as claimed in claim 1, wherein the apparatus is arranged to record sensed data sensed on a first occasion in association with content data sensed on the first occasion and to record at least some of the sensed data sensed on a second occasion in association with the content data sensed on the first occasion if the second occasion is within a predetermined time of the first occasion.

25. A portable electronic data capture apparatus as claimed in claim 1, wherein the apparatus comprises a switch that has a default configuration and is user-operable to move from the default configuration to a first actuation configuration and to move from a first actuation configuration to a second actuation configuration.

26. A portable electronic data capture apparatus as claimed in claim 25, wherein the apparatus is responsive to the switch to gather content data when the switch is moved to the first actuation configuration.

27. A portable electronic data capture apparatus as claimed in claim 25, wherein the apparatus is responsive to the switch to record content data when the switch is moved to the second actuation configuration.

28. A portable electronic data capture apparatus as claimed in claim 25, wherein the apparatus is responsive to the switch to perform an operation to prepare the audio and/or video sensor(s) for operation when the switch is moved to the first actuation configuration.

29. A portable electronic data capture apparatus as claimed in claim 25, wherein the apparatus is responsive to the switch to sense audio and/or video data by means of the audio and/or video sensor(s) when the switch is moved to the second actuation configuration.

30. A portable electronic data capture apparatus as claimed in claim 1, wherein the apparatus is arranged to record sensed data in association with an indication of the time at which the sensed data is generated.

31. A portable electronic data capture apparatus as claimed in claim 1, wherein the apparatus is arranged to record sensed data in association with data that is indicative of the parameters under which the apparatus was operating during the sensing of the audio and/or video.

32. A portable electronic data capture apparatus as claimed in claim 1, wherein the recorder is arranged to record the sensed data and the content data in the same data file.

33. A portable electronic data capture apparatus as claimed in claim 1, wherein the recorder is arranged to record the sensed data and the content data in linked files.

34. A portable electronic data capture apparatus as claimed in claim 1, wherein the apparatus is capable of present the sensed data and the content data to a user.

35. A portable electronic capture device as claimed in claim 1, wherein the recorder is arranged to record the sensed data and the secondary data in non-volatile memory.

36. A method of operating a portable electronic data capture apparatus, the method comprising:
sensing audio and/or video by means of one or more audio and/or video sensors so as to generate sensed data;
receiving a wireless signal carrying content data descriptive of the locale of the apparatus; and
recording the sensed data in association with the content data.

37. A content data distribution system comprising:
a plurality of transmitters, each transmitter being sited at a data site and being arranged to transmit wireless signals carrying content data descriptive of the locale of the transmitter; and
an electronic data capture apparatus, said apparatus comprising one or more audio and/or video sensors for sensing audio and/or video so as to generate sensed data;
a receiver for receiving a wireless signal carrying content data descriptive of the locale of the apparatus; and
a recorder for recording the sensed data in association with the content data, the electronic data capture apparatus being capable of receiving by means of the receiver thereof the wireless signals transmitted by the transmitters.

38. A content data distribution system as claimed in claim 37, wherein the wireless signals are radio signals.

39. A content data distribution system as claimed in claim 38, wherein the radio signals are short-range radio signals.

40. A content data distribution system as claimed in claim 39, wherein the wireless signals are Bluetooth signals.

41. A content data distribution system as claimed in claim 39, wherein the wireless signal are wireless LAN signals.

42. A content data distribution system as claimed in claim 37, wherein the apparatus is arranged to passively receive the wireless signal.

43. A content data distribution system as claimed in claim 37, wherein each of the said transmitters is associated with a respective receiver for receiving request signals from the portable electronic data capture device and is responsive to receiving such a request signal to transmit the said wireless signals carrying content data.

44. A content data distribution system as claimed in claim 37, wherein each of the said plurality of transmitters is a terrestrially mounted transmitter.

45. A content data distribution system as claimed in claim 37, wherein each data site is a fixed location.
